(19) United States
(12) Patent Application Publication
(10) Pub. No.: US 2001/0037311 A1
(43) Pub. Date: Nov. 1, 2001

(54) Efficient internet service cost recovery system and method

(76) Inventors: James McCoy, Mountain View, CA (US); Douglas Barnes, Mountain View, CA (US)

Correspondence Address: Patent Dept., Gray Cary Ware & Freidenrich, 3340 Hillview Avenue, Palo Alto, CA, 94304, US

(21) Appl. No.: 09/785,010

(22) Filed: Feb. 16, 2001

Related U.S. Application Data
(60) Provisional application No. 60/183,627, filed on Feb. 18, 2000.

(51) Int. Cl. G06F 17/60; H04K 1/00; H04L 9/00; G01R 11/56; G06F 15/173; G06F 15/16; G06F 17/00; G01R 21/133

(52) U.S. Cl. 705/65; 705/66; 705/64; 705/1; 705/412; 709/200; 709/218; 709/226

(57) ABSTRACT

The invention provides a distributed architecture where each portion of published content may be divided into numerous (i.e., hundreds or thousands) of small fragments, and scattered amongst the peer systems in the network. Retrieval of data may be accomplished by downloading the contents in parallel, locating a replica of an original fragment if a particular peer system serving the original fragment becomes overloaded or disconnected from the network. This architecture allows the invention to take advantage of the asymmetric nature of most user connections to the Internet by utilizing a collection of small agent applications (agents) running in parallel to deliver content rapidly across the network. The distributed load balancing system used by the invention functions as an agoric resource allocation system, with agents trading favors with a bartering network. By using pricing to signal resource contention, the agents can optimize the system according to local needs and obtain the most efficient usage from available network resources. The invention also keeps track of which users provide resources, content and indexing services within the network through an internal micropayment system which denominates internal tokens (credits) in the same resources needed to provide the services (i.e., disk space, bandwidth and CPU cycles). The distributed data service built on top of this micropayment system provides a reliable and scaleable method for peer-to-peer content distribution. In addition, by distributing accounting using a micropayment system denominated in payment-in-kind (i.e., barter), the system is less expensive to operate and easier to bootstrap than conventional systems. By using the resources themselves as the backing for the payment system instead of having a real currency serve as a proxy for these resources within the accounting system, the disadvantages plaguing conventional systems can be positively addressed.

The present invention relates to the Internet, and more specifically, to a micropayment accounting system for enabling in-kind transactions within a network.

### BACKGROUND OF THE INVENTION

The success of the Internet, aside from the ability to instantly connect millions of users, is due in large part to the wide availability of content. Users can locate just about anything they desire simply by searching for it on the Internet. However, cost recovery has been an unresolved issue for Internet companies for many years. Those companies wishing to make content available to subscribers via the Internet, at present, have the burdensome task of determining how to pay for the publication of that content. In many cases, the benefits of publishing content accrue to the user, not to the publisher.

Several attempts have been made to resolve the cost recovery issue, however, such attempts have met with limited success. The most prevalent approach has been to use advertising to pay for publishing content. However, this solution has a number of drawbacks. For example, to be effective, advertising has to become increasingly intrusive to the user. In addition, advertisers engage in a constant battle against software and services that are specifically designed to filter Internet advertisements.

Another approach involves the use of micropayments. Typically, micropayment systems attempt to drive the cost of payment transactions low enough to make extremely small (i.e., 1/1000^{th} of a cent) per-transaction payments cost effective. Such systems have been demonstrated, but never implemented on a large scale, primarily due to inherent development problems. For example, many early adopters of these systems are reluctant to pay money for transactions that in the past were free. Further, any system that is capable of “cashing out” a subscriber is dangerous as it requires careful screening or elaborate technical measures to prevent merchant fraud. In addition, these early systems did not adequately protect a user's privacy, and were relatively inefficient.

With the increasing popularity of dedicated Internet connections, such as DSL and cable modems, there is a growing pool of largely untapped computer resources (i.e., hard disk space, CPU power, bandwidth, etc.) available on the Internet. Several micropayment systems attempt to harness these largely untapped system resources. While this approach may be effective for projects that broadly reflect the goals and interests of a large segment of users that control large quantities of computing resources, these systems suffer from several disadvantages. For example, these systems are special purpose, in that they are designed only for a particular use. Also, the systems do not keep track of contributed resources, and rewards to those users who participate by contributing resources are generally meager and are not directly proportional to the users' contributions to the network.

Dial-up and other low bandwidth users constitute 80% of the systems connected to the Internet. Simple filesharing architectures are designed to move complete files, each transfer involving, for example, the exchange of an entire image, mp3, or video file. While this architecture works reasonably well for sharing small files among broadband users, the delay incurred in attempting to transmit a large file via a narrow bandwidth dial-up connection is generally too significant for most users to tolerate. Thus, most peer-to-peer solutions actively discourage dial-up users from providing resources to the network.

Conventional bulletin board systems utilized upload/download ratios for users using a centralized accounting system to track resource allocation on these systems, thus rationing the scarce dial-up lines in to the bulletin board systems themselves. In a peer-to-peer or distributed system, the scarce resources are a combination of network bandwidth, distributed storage space, and CPU cycles. Accounting for resource allocation and content royalty payments within these conventional systems is generally performed in a centralized manner. However, this is quite expensive and not very efficient. Digital micropayment systems can solve the distributed resource accounting problems within these systems, but users have problems with the strict per-unit/metered pricing for information resources that is inherent to these systems.

Accordingly, there is a need for a system that enables efficient cost-recovery that is independent of advertising, and allows users who can contribute resources to earn and spend credits on the network in relation to their contributions to the network. Further, there is a need for a system that protects user privacy and discourages fraud, creating an efficient, general purpose mechanism for buying and selling surplus computational resources across the network. It is to these ends that the present invention is directed.

### SUMMARY OF THE INVENTION

The invention provides a distributed architecture where each portion of published content may be divided into numerous (i.e., hundreds or thousands) of small fragments, and scattered amongst the peer systems in the network. Retrieval of data may be accomplished by downloading the contents in parallel, locating a replica of an original fragment if a particular peer system serving the original fragment becomes overloaded or disconnected from the network.

This architecture allows the invention to take advantage of the asymmetric nature of most user connections to the Internet by utilizing a collection of small agent applications (agents) running in parallel to deliver content rapidly across the network. The distributed load balancing system used by the invention functions as an agoric resource allocation system, with agents trading favors with a bartering network. By using pricing to signal resource contention, the agents can optimize the system according to local needs and obtain the most efficient usage from available network resources.

The invention also keeps track of which users provide resources, content and indexing services within the network through an internal micropayment system which denominates internal tokens (credits) in the same resources needed to provide the services (i.e., disk space, bandwidth and CPU cycles). The distributed data service built on top of this micropayment system provides a reliable and scaleable method for peer-to-peer content distribution. In addition, by distributing accounting using a micropayment system denominated in payment-in-kind (i.e., barter), the system is less expensive to operate and easier to bootstrap than conventional systems. By using the resources themselves as the backing for the payment system instead of having a real currency serve as a proxy for these resources within the accounting system, the disadvantages plaguing conventional systems can be positively addressed.

In an aspect, the invention affords a distributed system for publishing and retrieving content in a network. The invention includes a plurality of computer systems connected together in a peer-to-peer fashion, and one or more agent applications are associated with the computer systems for allowing the computer systems to publish and retrieve content from the network by initiating peer-to-peer interactions across the network involving given transaction costs. The computer systems have characterized network resources, such as available disk space, bandwidth, and CPU processing cycles, that can be contributed to the network in return for a predetermined amount of credits that are accumulated by those computer systems contributing resources to the network such that the computer systems can exchange the credits for performing interactions by the agent applications across the network. A credit server may also be provided for maintaining a database of previously used credits and for authorizing a valid credit transaction between interacting agent applications within the network.

The agent applications may comprise one or more client agent applications for enabling the computing systems access and interact with the agent applications in the network, one or more broker agent applications for performing brokering transactions between the agent applications in the network, one or more tracker agent applications for providing a listing of available resources within the network, one or more reputation agent applications for tracking the reputations of the computer systems in the network, and one or more payment agent applications for validating credit transactions within the network. The one or more broker agent applications directly provide brokered network resources to requesting computer systems within the network.

The one or more tracker agent applications may include one or more metatracker agent applications for maintaining the network location of the one or more active broker agent applications and a listing of the associated resources that those active broker agent applications broker within the network, one or more content tracker agent applications for storing dinodes to locate data blocks constituting a published data file on the network, and one or more publication tracker agent applications for recording storage locations on particular computing systems where the data blocks are stored. The tracker agent applications maintain public information relating to the various agent applications within the network.

The peer-to-peer interactions are performed in accordance with a micropayment transaction process that includes causing the client agent application associated with a first computing system to offer a given amount of credits to a broker application associated with a second computing system for performing the transaction within the network, causing the broker application to loan to the client application an amount of credits equal to the offered amount of credits to enable the first and second computing systems to engage in the transaction, causing the payment agent to verify the offered credits to insure that the offered credits have not been previously spent in a prior transaction and withdraw the offered credits from future use within the network, and if verified, causing the broker application to complete the transaction and retract the loaned credits in return for new credits that are associated with the second computing system in an amount equal to the amount of offered credits.

The broker agent applications publish content to the network by receiving an original file to be published to the network, dissecting the original file into a series of pieces of the original file, further dissecting each piece of the original file into a predetermined number of file blocks, generating a respective block identification tag for each of the file blocks, and storing the file blocks on one or more storage block servers within the network. The broker agent applications further generate a sharemap for the original file that describes how to reassemble the pieces of the original file from the file blocks and the original file from the pieces of the original file. Portions of the sharemap are stored at one or more dinodes within the network, and wherein the content tracker maintains information about the dinodes within the network so that the original file can be reassembled. The file blocks are retrieved in parallel to reassemble the original file, and only a portion of the file blocks are needed to reassemble the original file.

Further, the system uses a protocol for transmitting messages between the agents. The protocol includes a transport layer for moving secure data between the agents, an encryption and authentication layer for encrypting and decrypting the data, a conversation layer for associating initiating messages with their responding messages counterparts, and a transaction layer for enabling the interactions between the agents in the network.

The invention also affords a method for performing micropayment transactions in a distributed network. The method comprises the steps of offering a given amount of credits to a first party for performing a transaction within the network, loaning to a second party an amount of credits equal to the offered amount of credits to enable the first and second parties to engage in the transaction, verifying the offered credits to insure that the offered credits have not been previously spent in a prior transaction and withdrawing the offered credits from future use, and if verified, completing the transaction and retracting the loaned credits to the second party in return for new credits that are associated with the first party in an amount equal to the amount of offered credits.

Transactions may be direct, or indirect. During a direct transaction a request for network resources is transmitted directly to a broker agent that can fulfill the request by brokering the requested network resources. During an indirect, transparent transaction a request for network resources is transmitted directly to one or more intermediate broker agents and wherein those intermediate broker agents locate a particular provisioning broker agent that can fulfill the request for the least cost and transmit the request to that provisioning broker agent to fulfill the request by brokering the requested network resources.

In another aspect, the invention affords a method for performing a microaccount transaction in a distributed network. The method comprises the steps of initiating a transaction session between a requesting party and a fulfilling party within the network where the parties determine a financial relationship between them for guiding the transaction, creating a token for use in a transaction between the parties, the transaction having a given cost, and associating a digital signature with the token, verifying the authenticity of the token and associating an appropriate denomination with the token equal to the given cost for fulfilling the transaction, fulfilling the transaction in exchange for the token, and withdrawing the token from future use and associating a new token in an amount equal to the given cost with the fulfilling party.

The invention also provides a method for publishing content to a distributed network. The method comprises the steps of receiving an original file to be published to the network, dissecting the original file into a series of pieces of the original file, further dissecting each piece of the original file into a predetermined number of file blocks, generating a respective block identification tag for each of the file blocks, and storing the file blocks on one or more storage block servers within the network. The method further comprises the step of generating a sharemap for the original file that describes how to reassemble the pieces of the original file from the file blocks and the original file from the pieces of the original file. Portions of the sharemap are stored at one or more dinodes within the network. The file blocks are retrieved in parallel to reassemble the original file, and only a portion of the file blocks are needed to reassemble the original file.

In another aspect, the invention provides a protocol for transmitting messages between agents in a distributed network, comprising a transport layer for moving secure data between the agents, an encryption and authentication layer for encrypting and decrypting the data, a conversation layer for associating initiating messages with their responding messages counterparts, and a transaction layer for enabling interactions between the agents in the network. The transport layer utilizes TCP/IP to move secure data between the agents. The conversation layer assigns a nonce to an initiating message and monitors responding messages for the occurrence of the nonce that may be in a hashed format and associating the messages whose nonces match.

### BRIEF DESCRIPTION OF THE DRAWINGS

FIG. 1 is a diagram illustrating a peer-to-peer network in accordance with the invention;

FIG. 2 is a diagram illustrating a representative client computer system shown in FIG. 1;

FIG. 3 is a diagram representing the agents that may be stored in the computer systems to enable those systems to utilize and contribute to the network in accordance with the invention;

FIG. 4A is a flowchart illustrating an exemplary transaction operation performed in accordance with the invention;

FIG. 4B is a flowchart illustrating, in more detail, a credit loaning operation performed during a transaction in accordance with the invention;

FIGS. 5A and 5B are respective flowcharts illustrating an exemplary micro payment transaction in accordance with the invention;

FIG. 6 is an exemplary data structure representation of a digital token in accordance with the invention;

FIG. 7 is a flowchart illustrating an exemplary process for publicizing agent information to tracker agents in accordance with the invention;

FIG. 8 is a flowchart illustrating an exemplary process for retrieving information about agents and available resources within the network in accordance with the invention;

FIG. 9 is a flowchart illustrating an exemplary direct transaction process between a client agent and a broker agent in accordance with the invention;

FIG. 10 is a flowchart illustrating an exemplary indirect, transparent transaction between a client agent and a broker agent in accordance with the invention;

FIG. 11 is a flowchart illustrating an exemplary indirect, opaque transaction between a client agent and a broker agent in accordance with the invention;

FIG. 12 is a flowchart illustrating an exemplary process for publishing information content to the network in accordance with the invention;

FIG. 13 is an exemplary screen shot of a web browser accessing a website that is designed to enable users to interact with the invention;

FIG. 14 is an exemplary screenshot of a web browser showing a content menu that a user may utilize to search for content on the network;

FIG. 15 is an exemplary screenshot showing the results of a search for video clips using the content menu of FIG. 14;

FIG. 16 is an exemplary screenshot of a web browser showing a publish menu that a user may utilize to publish content to the network; and

FIG. 17 is an exemplary screenshot of a confirmation webpage that may be displayed to a user upon successfully uploading a file to the network.

### DETAILED DESCRIPTION OF THE PREFERRED EMBODIMENT

The present invention utilizes distributed computing, filesharing and microcommerce technologies to provide a unique, robust publishing system. While the invention is described in -the context of a publishing system, those skilled in the art recognize that the invention has broader utility, and the above is merely exemplary of a particular embodiment of the invention. A distributed system consists of a group of non alike computers that are connected together by a network and equipped with corresponding software so that the computers can coordinate their activities in a common scheme. As will be described below, each computer connected to the system is capable of contributing resources to the system, such as disk space, bandwidth, and CPU processing time. Accordingly, the network is configured as a peer-to-peer network enabling any computer connected to the network to communicate with any other computer without needing to communicate through a centralized server. Those skilled in the art will recognize that other network topologies can be utilized, and the above is merely exemplary.

The most prevalent use of peer-to-peer networking is the trading of music across the Internet. Systems such as Napster have been developed specifically to foster that purpose. However, the invention is not limited in its capabilities to publish particular types of content, enabling users to publish and share any form of content across the network. As will be described below, publishing and retrieval of content across the network is accomplished anonymously. Further, conventional systems suffer from inherent disadvantages, some of which were described above, which the present invention purports to solve.

Advantageously, the invention utilizes a unique “economy” that is based on a global market for unused network resources. For example, resources such as disk space, bandwidth, CPU processing cycles, among others, may be bought and sold using a digital currency (credits) denominated in these same resources. As will be described below, each peer-to-peer interaction across the network involves some transaction cost. The system tracks these transactions, performing bookkeeping for users and serving as a trusted third party that ensures honest transactions between users.

The invention provides a stable, reliable and scalable system for publishing and downloading content. Subscribers contribute resources to the network community by performing one or more services (for instance, storing blocks of data or hosting a tracking or relay service), in return for digital currency (credits), that they can use to browse and download available content within the network, or otherwise transact with the network. In addition, subscribers can also directly purchase credits without contributing resources to the network.

In a traditional client-server distributed system, application software is usually split between server tasks and client tasks. A client system typically transmits a request to the server and the server responds accordingly. A part of the system that prepares or exchanges information on behalf of a server or a client is known as an agent. In a peer-to-peer system, each agent performs both server and client roles. The invention includes a global pool of agents performing various functions, such as relaying messages, tracking resources and other information, publishing content, storing content, etc. Each agent operates on behalf of the user, attempting to maximize value for the user and responds to a standard set of messages depending on the part it plays in the system.

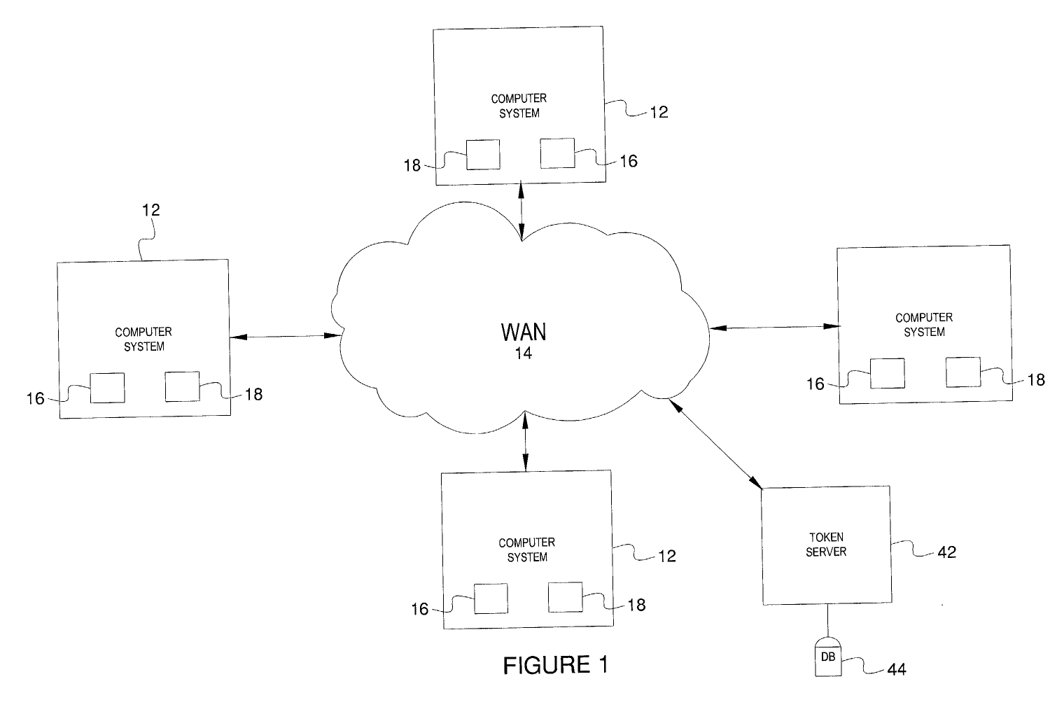

FIG. 1 is a diagram illustrating a peer-to-peer network in accordance with the invention. The system 10 may include a plurality of clients 12 connected in a peer-to-peer fashion across a wide area network (WAN) 14, such as the Internet, or more particularly, the World Wide Web. The clients 12 may contain one or more pieces of software code 16 (agents) that may be stored on these machines and may be executed by a respective microprocessor 18 in order to operate as the invention. The Internet 14 permits the machines 12, when accessed by other machines 12 in the network 14, to communicate with each other in order to serve or host various requests or operations and to otherwise interact with each other.

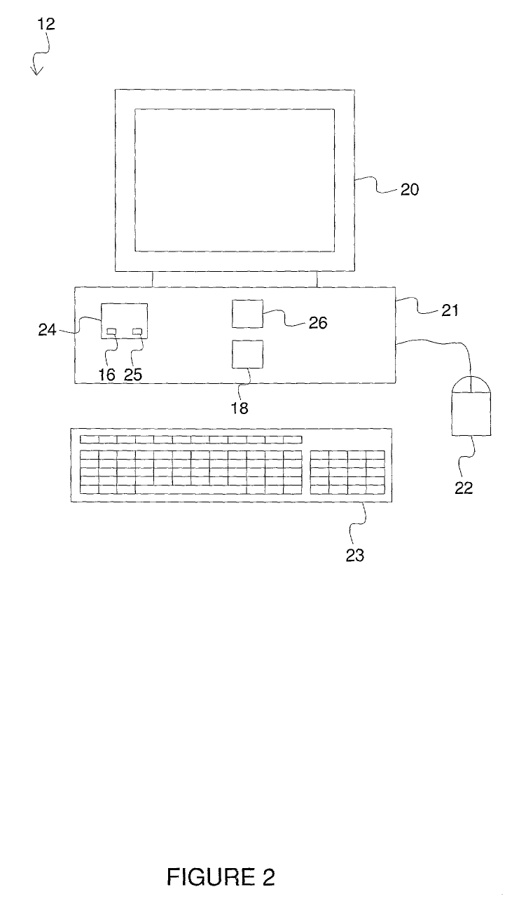

FIG. 2 is a diagram illustrative a representative client computer system 12 that is connected to the network 14 as shown in FIG. 1. Representative client computer systems 12 may include a display device 20, a chassis 21, and one or more user input devices, such as a mouse 22 and a keyboard 23. The chassis 21 may house a permanent storage system 24, such as a hard disk drive, optical disk drive, tape drive, or the like, which may store one or more software applications such as a web browser application 25, and one or more agents 16. The client computer system 12 may have a memory 26 resident therein and the software application(s) from the disk 24 may be transferred to the memory 26 to be executed by a CPU 18 in the computer system 12. The browser application 25 may be configured to connect the client computer system 12 with other machines 12 in the network 14 and receive graphical information (i.e., web pages) that may be displayed on the display device 20 to a user. The browser application 25 may also permit the client computer systems 12 to interact with the other machines 12 in order to serve or host requests and operations in accordance with the invention.

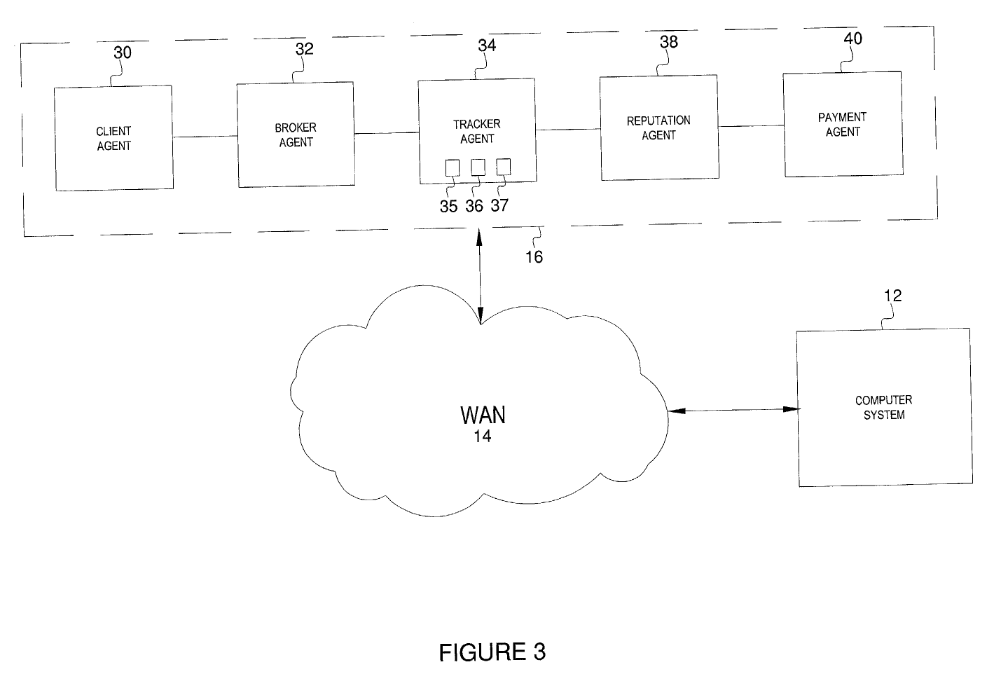

FIG. 3 is a diagram representing agents 16 that may be stored on the client computer systems 12 to enable those systems 12 to utilize and contribute to the network 14 in accordance with the invention. The client computer systems 12 may include a first software module 30 (i.e., a client agent) that is operable to enable these machines 12 to access the network 14 and be capable of consuming system resources provided by other systems 12 connected to the network 14. A user may download and install the client agent 30 from the Internet using techniques that are well known in the art, or may purchase, or otherwise obtain the client agent and directly install the client agent 30 onto the computer system 12.

A second software module 32 (i.e., a broker agent) may also reside on the computer systems 12 that functions as an intermediary for selling (brokering) network resources within the network 14 and/or directly providing those resources to other systems 12 connected to the network 14. A user may download and install the broker agent 32 from the Internet using techniques that are well known in the art, or may purchase or otherwise obtain the broker agent 32 and directly install the broker agent 32 onto the computer system 12. The broker agent 32 (broker) functions as the user's “middleman” between the user and the network, handling the user's transactions and overseeing the activities of the broker's tracker agents (which are described below). When installed, the broker agent 32 is loaded into the user's web browser application 25 to enable the sharing and downloading of published content and resources over the network 14.

A third software module 34 (i.e., a tracker agent) may also reside on the computer systems 12 that provides a listing of available resources for sale across the network 14. A user may download and install the tracker agent 34 from the Internet using techniques that are well known in the art, or may purchase or otherwise obtain the tracker agent 34 and directly install the tracker agent 34 onto the computer system 12. Preferably, the system may utilize multiple types of tracker agents, such as a metatracker agent 35, a content tracker agent 36, and a publication tracker agent 37. The metatracker agent 35 notes the network location of the broker agents 32 that are presently online, along with their public ID keys and a list of the services that they provide (i.e., a list of the resources that they can contribute to the network 14). The content tracker agent 36 stores dinodes (described below) which enable the system to locate the data blocks that constitute a published file, effectively functioning as the network's internal search engine. The publication tracker agent 37 records which block server (contributed storage space on a contributing user's machine 12) stores which blocks of data and which of those blocks were published most recently to the system. These tracker agents 34 will be described in more detail below.

A fourth software module 38 (i.e., a reputation server agent) may reside on the computer systems 12 that tracks the reputations of the various parties involved in resource transactions on the network 14. A user may download and install the reputation server agent 38 from the Internet using techniques that are well known in the art, or may purchase or otherwise obtain the reputation server agent 38 and directly install the reputation server agent 38 onto the computer system 12.

Finally, a fifth software module 40 (i.e., a payment server agent) may reside on the computer systems 12 that issues and redeems credits (digital currency) to facilitate and enable resource transactions within the network 14. A user may download and install the payment server agent 40 from the Internet using techniques that are well known in the art, or may purchase or otherwise obtain the payment server agent 40 and directly install the payment server agent 40 onto the computer system 12.

While the above are described as disparate agents 16, those skilled in the art recognize that their functionality could be provided in a single agent application, or in an alternative number of agent applications, which may reside solely on a particular machine 12 in the network, on all the machines 12 in the network 14, or as distributed agents 16 across the network 14 without departing from the invention. Additionally, the software code that implements these agents 16 may be configured in the same executable code, or may be implemented as independent executable programs. Each of these agents 16 and their functionality will be described in more detail below.

The invention provides a particular protocol for communicating messages between the agents in the network. A protocol is a set of rules that enables machines or pieces of software to coordinate with each other. In accordance with the invention, the preferred protocol is message based and asynchronous. In a message based protocol, two parties in a conversation exchange messages without being directly connected. In an asynchronous communication, one side need not wait for the other side to return a response before sending another message.

In accordance with the invention, the protocol includes multiple layers, such as a transport layer, an encryption and authentication layer, a conversation layer, and a transaction layer. The transport layer moves secure data from one party to another through TCP/IP. The encryption and authentication layer provides secure and private communication between two parties by encrypting and decrypting each message, converting plain text to cipher text. Advantageously, the authenticity of each message is guaranteed by validating the message's digital signature, which is generated by the holder of the sender's private key, while the signature itself is also encrypted, for example using the RSA encryption algorithm.

In accordance with the invention, the are different types of messaging, initiating and responding. The conversation layer matches an initiating message to its responsive counterpart by first assigning a random number (a nonce) to the initiating message, and then waiting for that number (in an encrypted hash) to return with the response. When the first party receives the right hash in response, it knows that the correct recipient received the message, since it is nearly impossible to create the hash without knowing the nonce in the initiating message.

Every conversation between two agents involves an offer of digital currency. The initiating message includes a request for service and an IOU, while the responding message includes acceptance or rejection of that offer. When an initiating message and a digital currency offer arrives, the respondent checks the price list for services (which is user-configurable) to determine whether the offer is acceptable. Then, the respondent refers to the initiator's credit limit, based on the initiator's reputation, and if the digital currency offer is acceptable, the respondent accepts the IOU and provides the service.

Outgoing messages filter through the protocol layer from the top layer down. That is, at the transaction layer, an offer of digital currency is made or evaluated. Then, the message is passed down to the conversation layer, where the message is matched to its counterpart by its nonce. From there, the message is encrypted at the encryption/authentication layer, and is dropped down to the transport layer where the message is sent on its way.

In contrast, incoming messages filter through the protocol layer from the bottom layer up. The transport layer takes the message and passes it up to the encryption layer. Further, the transport layer prepends a 32-bit number that represents the length of each message to each message, so that the encryption layer knows how much data to read before it stops decrypting. The encryption layer also validates the message's digital signature, and then moves the message to the conversation layer. If the broker happens to be conducting, for example, twenty conversations at once, the conversation layer knows which conversation the new message belongs to by following the trail of nonces and hashes. The message works its way up to the transaction, where the offers are tendered, then accepted or declined.

In accordance with the invention, a flexible reputation system is provided that may be used for a variety of functions. Each broker maintains its own local database of reputations for other brokers, including a list of others with which it has done business and information about those transactions. This history is comprised of their response times to queries as well as their dependability from being online when queried, reliability for content and information delivery, and the credit limit extended to them.

The fundamental reputation factor in the network is credit rating. Each broker is associated with some bank account, and a credit rating that expresses the average flow of digital currency through the account, and whether the account has ever tried to spend the same digital token twice. The credit rating will determine how much credit one broker can grant to another at the start of the conversation.

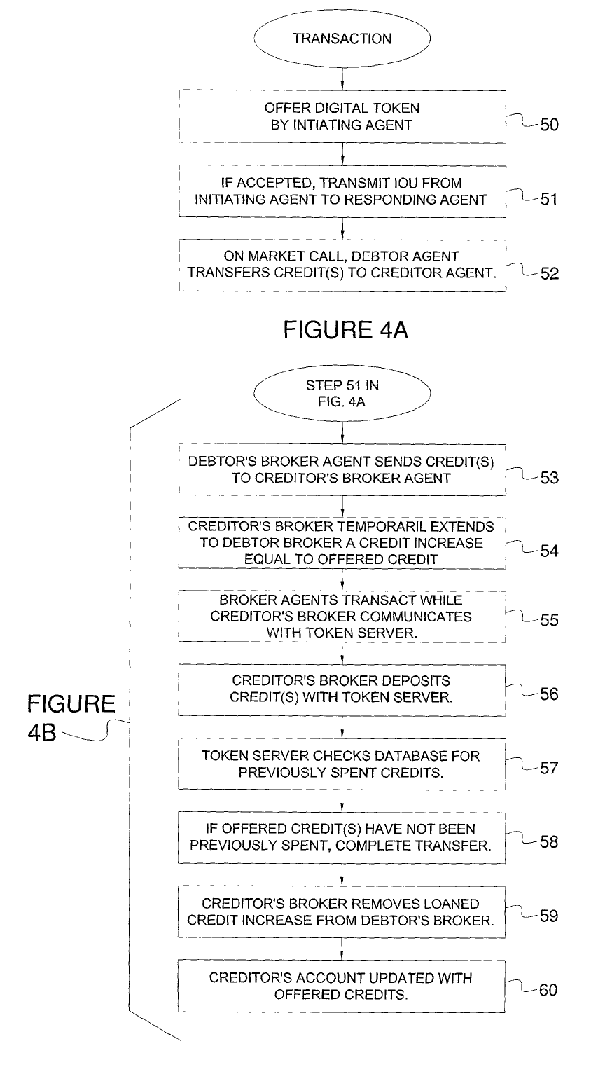

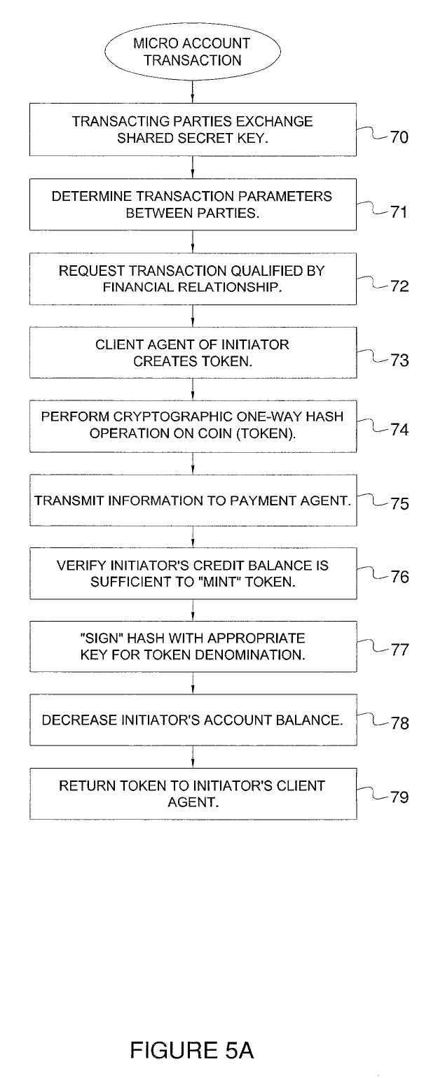

In accordance with the invention, the system operates in accordance with a bartering system, preferably utilizing a digital token micropayment system with peer-to-peer microcredit arrangements. Thus, transactions between various agents 16 in the system preferably involve micro accounting principles. FIG. 4A is a flowchart illustrating an exemplary transaction operation in accordance with the invention. In any communication session between two agents 16 in the network, an offer of digital tokens is made (Step 50); however, the digital currency is not actually transferred at that time. Instead, an IOU for the digital currency may be transmitted from the initiating agent 16 to the responding agent 16 (Step 51). That is, one agent 16 extends the other a bit of credit in order to complete the transaction, and the creditor agent 16 “calls its market” once the debtor agent 16 has reached its credit limit. The creditor agent 16 could also “call its market” when a particular IOU total has reached a threshold amount. At that time, the debtor agent 16 balances out its account by transferring one or more digital tokens from its account (maintained by a token server, reference number 42 in FIG. 1) to the creditor agent's account (Step 52).

Step 51 above is illustrated in more detail in FIG. 4B. Referring to FIG. 4B, the broker agent 32 keeps track of the number of digital tokens that are owed between agents 16. In accordance with the invention, the debtor user's broker agent 32 initiates token transfer by sending the creditor user's broker agent 32 a token (Step 53). The creditor user's broker agent 32 temporarily extends to the debtor user an increase in credit that is equal to the token (Step 54), thus enabling the broker agents 32 to continue to transact while the creditor's broker agent 32 communicates with the token server 42 (FIG. 1) (Step 55). The creditor user's broker agent 32 deposits the token with the token server 42 (FIG. 1) (Step 56) after which the token server 42, acting as an intermediary in the transaction, checks its database 44 (FIG. 1) for all tokens that have been spent (Step 57), and if the particular token has not been previously spent, completes the transfer (Step 58). Otherwise, a fraud attempt is detected and the transfer is halted. Preferably, each token is digitally signed to prevent forgery, and each token is used only once to protect against double spending of tokens. After the token transfer is complete, the creditor user's agent 32 removes the temporary increase in credit loaned to the debtor user's broker agent 32 (Step 59), and the creditor user's agent 32 withdraws a fresh token from the token server 42 (Step 60).

The token server 42 (FIG. 1) maintains a list of current user accounts and their balances, but each account is not directly linked to a single user identity. Users can open multiple accounts that can be used for different purposes, each preferably maintained under a different public-key pseudonym. For the sake of efficiency, the system preferably allows for different forms of accounts, such as macro accounts and micro accounts. Macro accounts are established between the various users and a payment server agent 40. The manner in which these accounts are opened by users is not important to the invention, but generally are initialized by indicating a zero balance (for example if the account holder is planning to initially earn credits), contain purchased credits, and/or contain free credits offered as a promotion to new users. The number of available credits may be determined, for example, based on a combination of available resources that can be contributed to the network 14, such as excess CPU time, network bandwidth, and disk storage.

Macro payments may be initiated between agents 16 of the system using various financial cryptology technologies, such as digitally signed “cheques,” or the transfer of anonymous or identity agnostic coins or “bearer certificates.” Either approach generally requires a substantial amount of network latency and/or computational effort to accomplish. In addition, they generally require the involvement of trusted third parties and some degree of centralization. Therefore, they are not particularly suitable for small payments. Alternatively, micro accounts may be established in several ways. For example, one party may make an opening macro payment to another party, or one party may extend credit to the other party (for example, based on that party's reputation), and when the balance of payments reaches a given size, the owing party may settle up the account with the owed party using a macro payment.

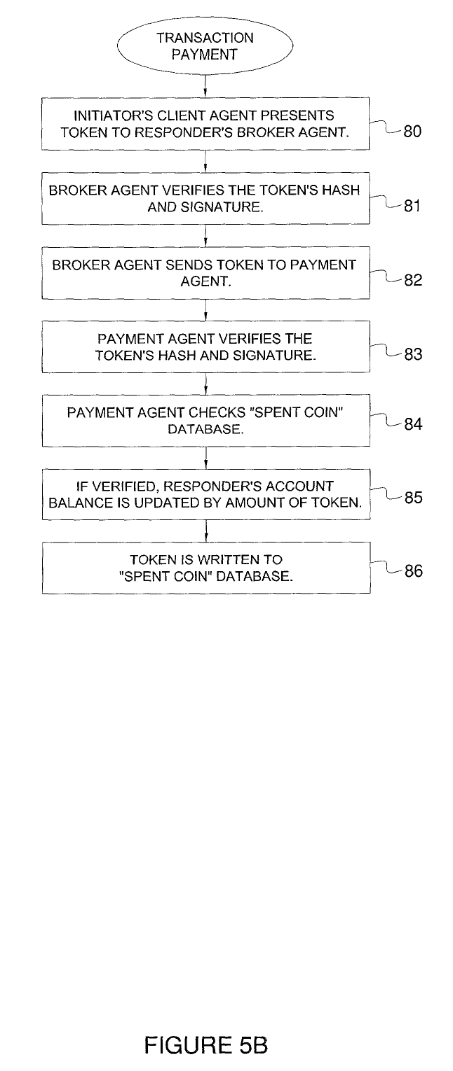

FIGS. 5A and 5B are respective flowcharts illustrating an exemplary micro account transaction in accordance with the invention. An agent 16 (usually the client agent 30) may be associated with an account maintained by the payment server agent 40. Interested transacting parties may initiate a communication session by, for example, utilizing a form of public key cryptography (i.e., RSA) to exchange a shared secret key (Step 70). This secret key may be referenced in subsequent communications between the parties using, for example, a sessionID. Other than the sessionID, other communications between the parties may be encrypted using, for example, a symmetric cypher (i.e., DES). The parties may then determine their financial relationship (i.e., who is paying whom for what, whether credit is to be extended, whether a macro coin is to be deposited, etc.) (Step 71), and the parties can request the other to perform transactions qualified by their financial relationship (Step 72).

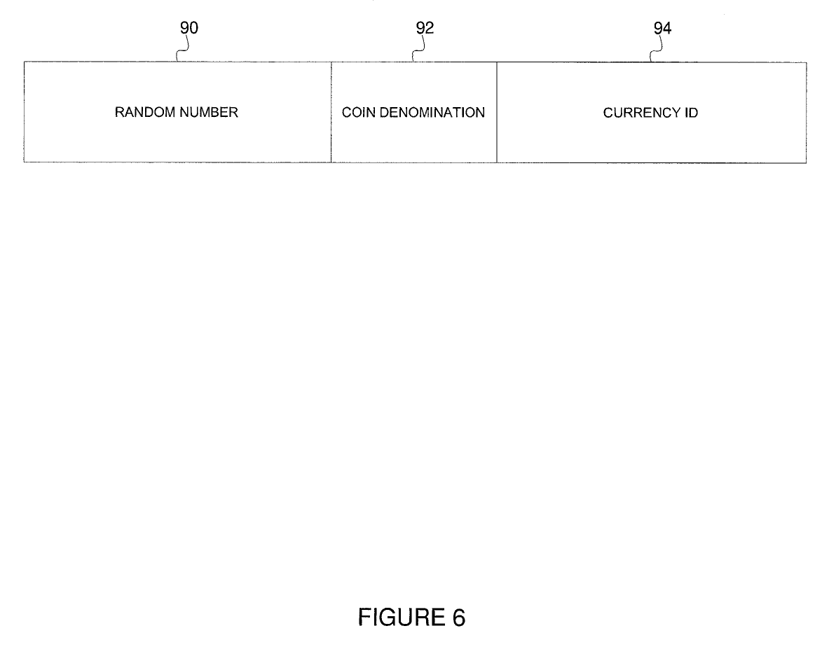

Once a session has been initiated, macro coin exchange may occur as follows. The client agent 30 may create a “coin” (token) (Step 73) which is preferably implemented as a data string containing (at a minimum) the following elements: a large random number 90, the denomination of the coin 92, and the currency ID 94 of the coin. An exemplary data structure representation of a digital token is shown in FIG. 6. Returning to FIGS. 5A and 5B, a cryptographic one-way hash of the coin may be performed (Step 74), with the result transmitted to the payment agent 40 together with a request to verify the transaction with a representative key for the denomination of the coin (Step 75). The payment server agent 40 may then verify that the user's credit balance is sufficient to mint the coin (Step 76), and may sign the hash with the appropriate key for the denomination (Step 77). The payment server agent 40 then may decrease the user's account balance accordingly (Step 78), and return the coin to the client agent 30 (Step 79). The client agent 30 may retain the coin until ready to make a payment. When making a payment, an exemplary process shown in the flowchart of FIG. 5B, the client agent 30 presents the coin to a broker agent 32 (acting on behalf of the merchant user) (Step 80), which verifies the hash and signature (Step 81), and transmits the coin to the payment agent 40 (Step 82). The payment agent 40 verifies the hash and signature (Step 83), checks a “spent coin” database (to prevent multiple spending) (Step 84), increases the merchant user's account balance (Step 85), and writes the coin to the “spent coin” database (Step 86).

In accordance with the invention, transactions within the system may be established within the context of a communication session that establishes a financial relationship between the transacting agents of the system. This allows for both efficient cost recovery and is helpful in preventing denial of service incidences. In the following description references to “templates” used for standardizing queries and responses within the system are not intended to exclude other methods of standardizing the protocol between communicating agents, for example, hard-coding the format for a fixed number of types of information.

In accordance with the invention, agents 16 can learn about other agents 16 in the network 14 and about the resources that are available (offered) by particular ones of those agents 16 via the tracker agent 34 (FIG. 3). As described above, the tracker agent 34 is designed to locate resource availability, using criteria such as the types of information being offered by systems on the network 14, the reputations of parties involved in transactions on the network, and various market forces within the system, among others. Agents 16 may also learn about other tracker agents 34 and their respective capabilities through special tracker agents 34 called root trackers (not shown in FIG. 3). The details of how tracker agents 34 store and retrieve information has little effect on the overall operation of the system. Various standard techniques, such as simple keyed files, full-fledged relational databases, and object-oriented databases may be used. It is preferred, however, that the tracker agents 34 respond to a standard protocol and that standard templates be used for external requests to store and retrieve information within the network 14.

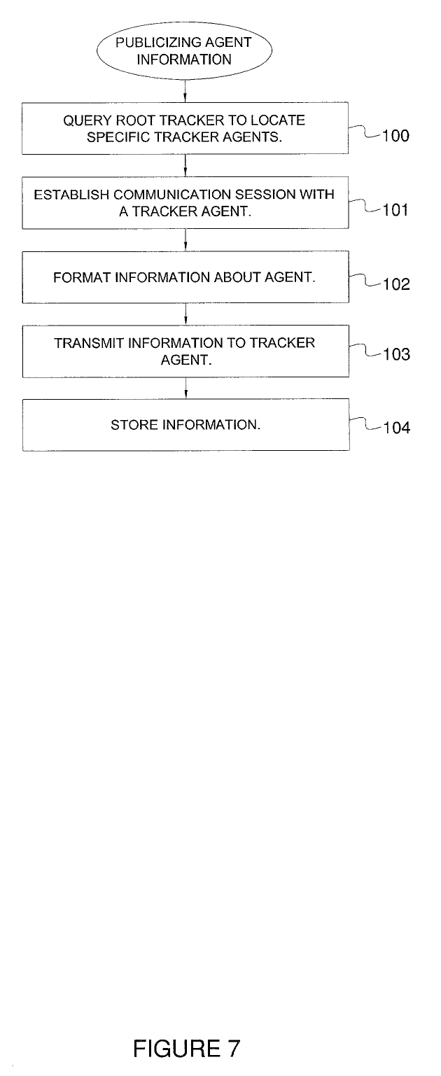

When an agent 16 publicizes some aspect of itself, so that it may be known to tracker agents 34, it may do so as follows, the process of which is illustrated in the flowchart shown in FIG. 7. First, the agent 16 may query a root tracker to locate one or more tracker agents 34 that specifically maintains the type of information relating to the agent 16 (Step 100). Then, the agent 16 may establish a standard communication session, as described above, with the tracker agent 40 (Step 101). The agent 16 then formats its information using, for example, a standard template for indicating that type of information (Step 102), and the agent 16 sends the information to the tracker agent 40 (Step 103), potentially charging the tracker agent user's micro account (since this operation constitutes a transaction within the network). Then, the tracker agent 40 may store the information (Step 104) in an associated database so that it may retrieve appropriate information when queried by another agent 16.

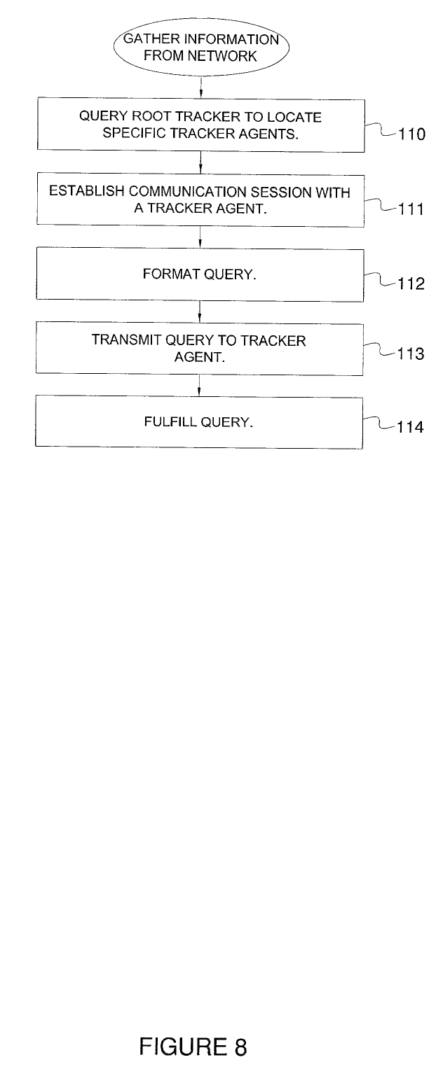

Whenever an agent 16 wishes to learn about another agent 16 or type of resource available on the network 14 it may do so as follows, the process of which is illustrated in the flowchart shown in FIG. 8. First, it may query a root tracker to locate one or more tracker agents 40 in the network that maintains particular types of information (Step 110). Then, the agent 16 may establish a standard communication session, as described above, with the tracker agent 40 (Step 111). After a communication session is established, the agent 16 may format a query using, for example, a standard template for indicating the type of desired information, for example, resource type, resource quantity, resource index, resource index ranges, broker reputation, broker reliability, broker cost, broker proximity, maximum number of records to return, as well as other information (Step 112) and transmit that information to the tracker agent 40 (Step 113). The tracker agent 40 then may return a number of information records relating to the query to the requesting agent 16 (Step 114) and may charge the requesting agent user's micro account (since this operation constitutes a transaction within the network 14).

In accordance with the invention, broker agents 32 can either sell network resources on their own account, or act as consolidating agents for other brokers 32. When acting on their own account, the transaction is referred to as a direct transaction. When acting as a consolidating agent, the transaction is referred to as an indirect transaction. When involved with an indirect resource transaction, the broker agent 32 being dealt with by the client agent 30 is referred to as an intermediate broker, and the broker agent 32 that fulfills the client agent's request is referred to as the provisioning broker. Client agents 30 can initiate two types of indirect resource requests: transparent resource requests and opaque resource requests. Transparent resource requests are visible to the intermediate broker, while opaque requests are not.

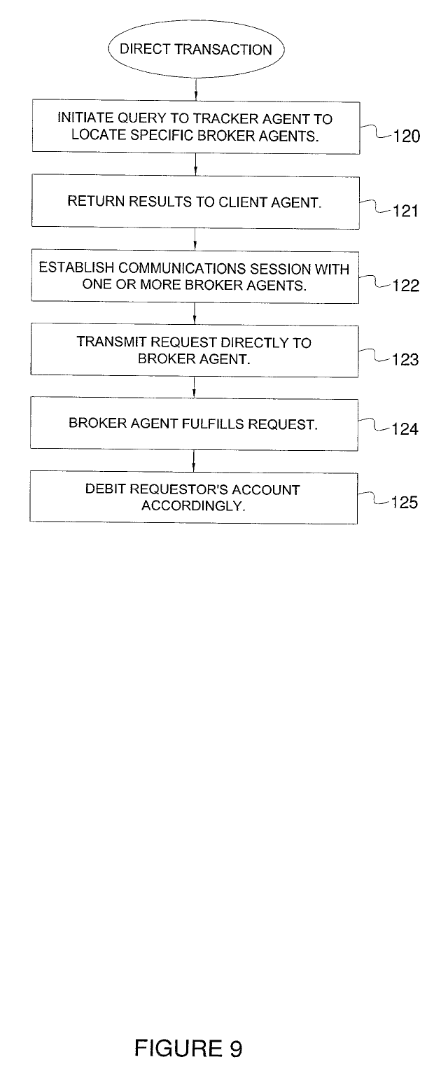

FIG. 9 is a flowchart illustrating a direct transaction between a client agent 30 and a broker agent 32 in accordance with the invention. The client agent 30 may initiate a query to a tracker agent 34, as described above, to locate a subset of the broker agents 32 on the system that deal in the desired resource (Step 120), based, for example, on a set of criteria, such as reputation, proximity and cost, among others. The tracker agent 40 may return the appropriate information to the client agent 30 (Step 121). Then, the client agent 30 may establish a standard communication session (and payment terms), as described above, with a subset of the broker agents 32 that can satisfy the client agent's resource needs (Step 122). Finally, the client agent may transmit an appropriate resource request, for example, by indicating the request in an appropriate template, directly to the broker (Step 123), whom may fulfill the request by selling the requested resource(s) to the requesting user (Step 124), and charge the requesting user's account accordingly (Step 125).

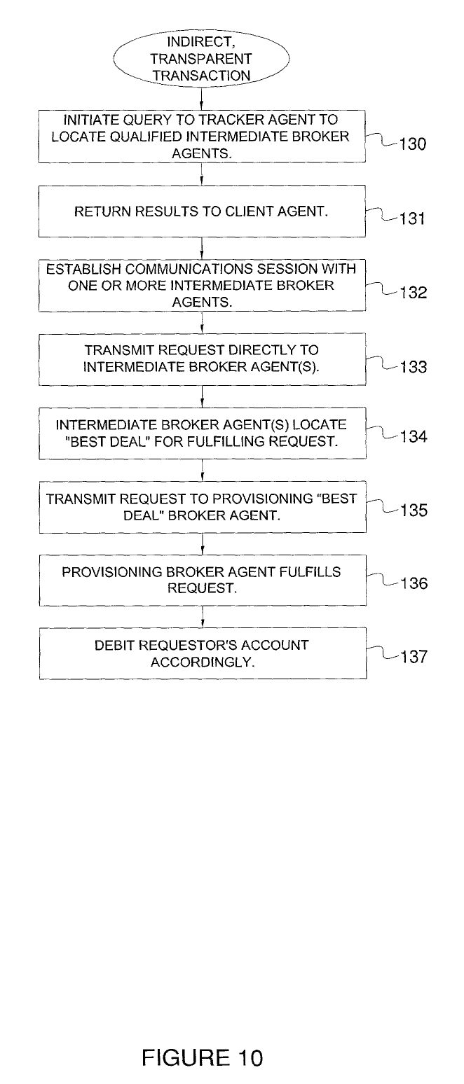

FIG. 10 is a flowchart illustrating an indirect, transparent transaction between a client agent 30 and a broker agent 32 in accordance with the invention. The client agent 30 may initiate a query to a tracker agent 34, as described above, to locate a small set of qualified intermediate brokers on the system that deal in the desired resource (Step 130), based, for example, on a set of criteria, such as reputation, reliability, proximity and cost, among others. The tracker agent 40 may return the appropriate information to the client agent 30 (Step 131). Then, the client agent 30 may establish a standard communication session (and payment terms), as described above, with one or more of the intermediary brokers (Step 132), and may transmit an appropriate resource request, for example, by indicating the request in an appropriate template, directly to respective intermediate brokers (Step 133), whom may locate the “best deal” on the requested service (Step 134), for example by accessing previously cached information about the availability of resources on the network 14, or by initiating tracker agent queries to locate the “best deal” on the requested service. Finally, the intermediate broker may transmit the request to the identified provisioning broker offering the best deal for that resource (Step 135), and that provisioning broker may fulfill the client agent's request (Step 136), charging the requesting user's account accordingly (Step 137).

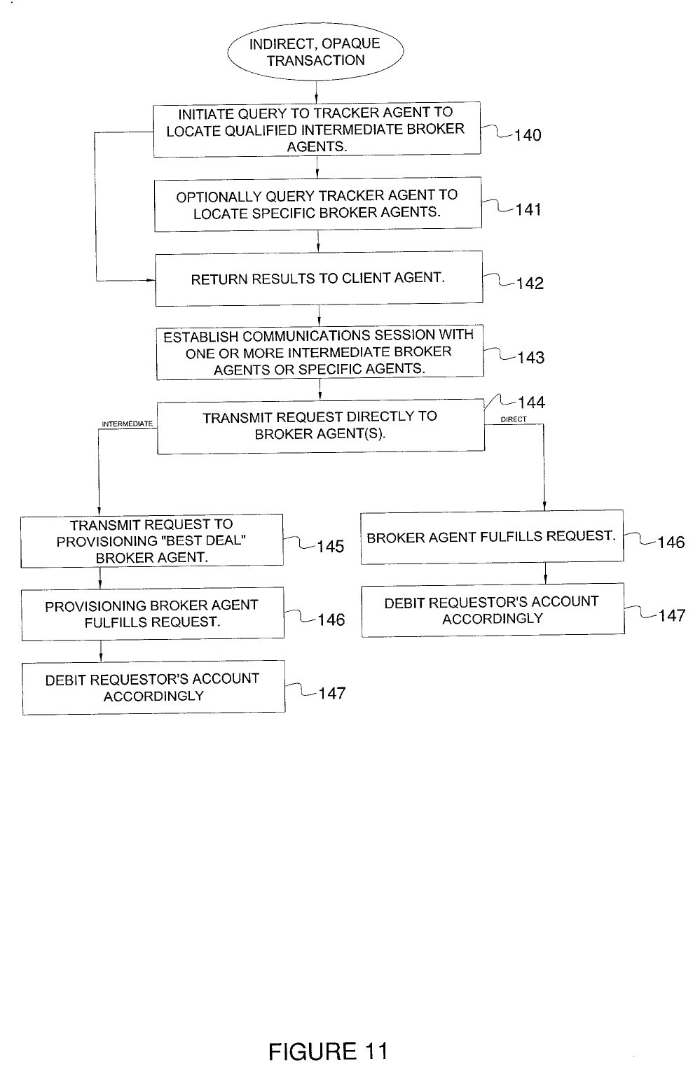

FIG. 11 is a flowchart illustrating an indirect, opaque transaction between a client agent 30 and a broker agent 32 in accordance with the invention. The client agent 30 may initiate a query to a tracker agent 40 to locate a small set of qualified intermediate brokers on the system that deal in the desired resource (Step 140), based, for example, on criteria such as reputation, reliability, proximity, and cost. Also, the client agent 30 may use a query to a tracker agent 40 to locate a subset of the broker agents 32 that deal in the desired resource (Step 141). The tracker agent 40 may return the appropriate information to the client agent 30 (Step 142). The client agent 30 may then establish a communication session (and payment terms), as described above, with one or more intermediate brokers (Step 143), and may transmit an appropriate resource request, for example, by indicating the request in an appropriate template, to those brokers (Step 144). Preferably, each opaque client request that is sent through an intermediate broker may contain information relating to a standard session wrapper for the intermediate broker, an optional request to charge the client's account by a fixed credit amount, which can be passed on to a provisioning broker or tracker, and a completed (and possibly encrypted) resource request template or tracker query template that can be transmitted to the provisioning broker or to a tracker agent 40. The intermediate broker may transmit the request to the identified provisioning broker offering the best deal for that resource (Step 145), and that provisioning broker may fulfill the client agent's request (Step 146), charging the requesting user's account accordingly (Step 147). [Note to Jim: Does this accurately describe the indirect, opaque transaction? It seems quite similar to the indirect, transparent transaction described above.]

In accordance with the invention, agents 16 may report summary information about other agents 16 in the system to a reputation agent 38 (FIG. 3). Users of low-reputation agents 16 may be charged a nominal fee to become part of the system while users of other agents 16 may not be charged. A potential disadvantage in establishing reputation agents 38 for the system is how to prevent “fluffing” (i.e., unfairly inflating a component's reputation) or “slamming” (i.e., unfairly reducing a component's reputation). To avoid this problem, reputation information is carefully weighed. For example, since agents 16 could be pseudonymous, focus is preferably on positive reputation. Moreover, it is preferred to allow a single summary report for a fixed time period, and to normalize reports from a single entity. In addition, preferably greater weight is given to reports from agent owners that perform more transactions in a given time period, and to those who have been active for a longer period of time.

In general, all agents within the system are autonomous agents acting on behalf of their owner/operators. Therefore, in order to realize the benefits of the system, it is preferable that the agents be hard wired or configured to take advantage of the market-driven nature of the system. That is, each agent 16 should be able to raise its price as demand increases (if for no other reason than to avoid overload), and to lower its price when demand decreases (in order to maximize return on what are usually non-marginal cost resources).

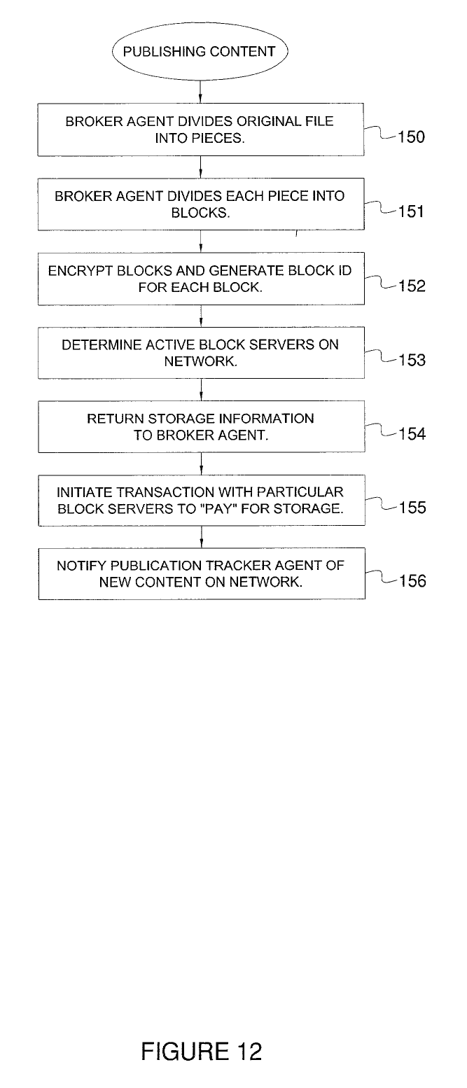

Information may be published to the network 14 via the broker agent 32 in accordance with an exemplary process such as is shown in the flowchart of FIG. 12. Preferably, the broker agent 32 first breaks the original file into several pieces (the larger the file, the greater the number of pieces) (Step 150), and secondarily breaks each piece into eight blocks (Step 151), any four of which are sufficient to reconstruct the original piece. These data blocks may be run through a cryptographic hash function that scrambles the blocks and generates a unique identity tag (a block ID) for each block (Step 152).

After a bitmask (block ID) has been assigned to each data block, the broker agent 32 learns from the metatracker agent 35 which block servers (contributed storage of computers within the network) are running on the network (Step 153) using standard query templates as described above. These block servers present a list of their prices for storage and the range of block IDs (or bitmasks) that they will accept which is communicated to the client agent 30 (Step 154). The broker agent 32 then pays the right block servers for their service (Step 155). When each block has been stored, the broker agent 32 notifies the publication tracker agent 37 that new blocks are available for indicating content at their respective addresses (Step 156).

The broker agent 32 may also generate a “sharemap” which explains how to reassemble the pieces of the file from the data blocks and then the file from the pieces. This sharemap may be broken up and encrypted as described above. A list of the blocks which make up the sharemap is referred to as a dinode. The primary job of a content tracker 36 is the storage of these dinodes and maintenance of the system's knowledge about the file (i.e., content description, publisher's pseudonym, etc.).

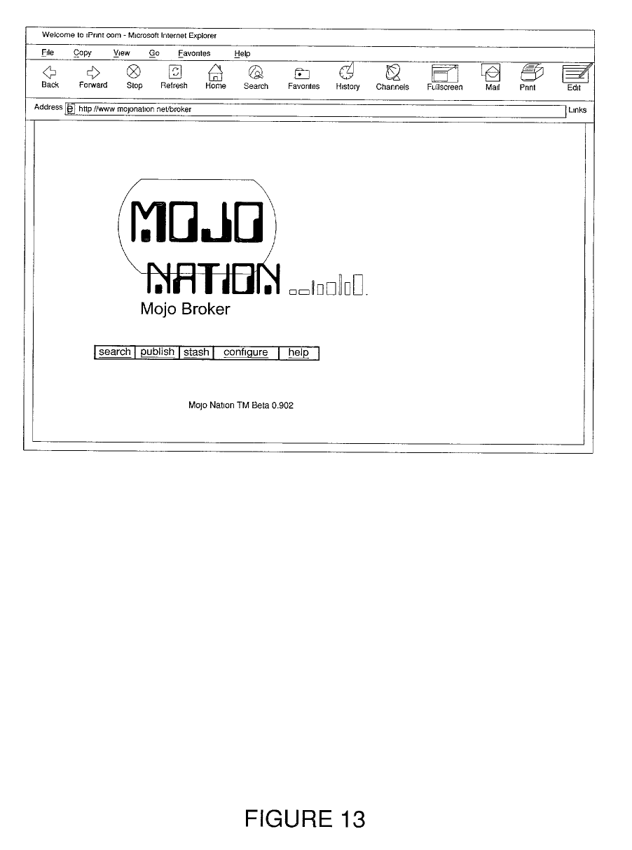

File retrieval may be initiated by using a content search. FIG. 13 is an exemplary screen shot of a web browser accessing a website that is designed to enable users to use the invention. Different options may be available to a user accessing the website. For example, the user may elect to search published content by selecting the “search” hyperlink 160 or other equivalent selecting means, the user may elect to publish new content to the network by selecting the “publish” hyperlink 162 or other equivalent selecting means, the user may elect to stash [Note to Jim: Please describe this feature.], or the user may elect to configure his/her interactivity with the invention by selecting the “configure” hyperlink 166 or other equivalent selecting means.

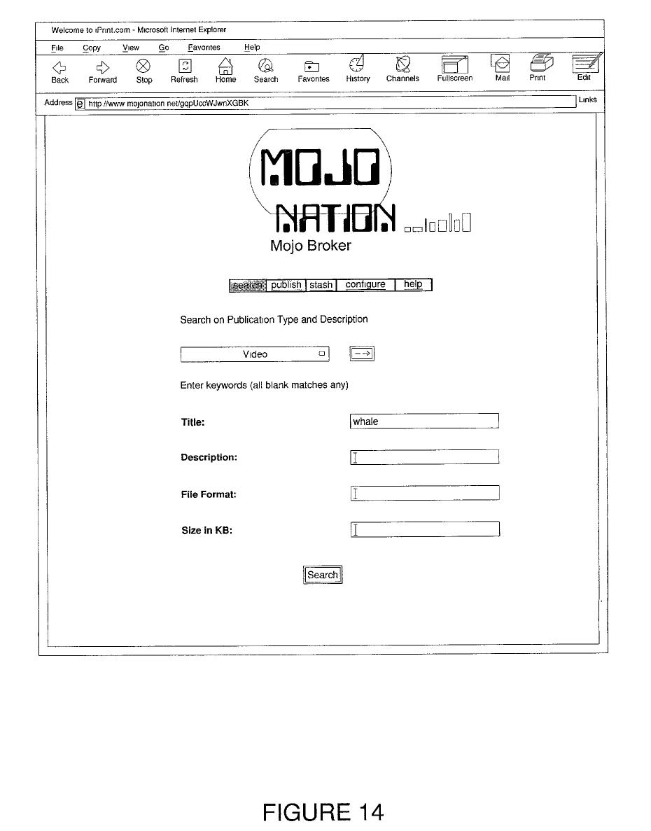

Upon selecting the “search” hyperlink 160, a user may search the network for digital content, such as music files, video images, software, documents, and other types of files stored on the network. The user may be presented with a content menu 170, an exemplary screenshot of which is shown in FIG. 14, and can interact with the menu 170 to select a type of content from a drop down menu 172 or other listing means, and may enter desired search terms into variously provided data fields 174. For many content types, a user may also limit his/her search to files of a certain type. For example, if searching for video clips, the user may limit the search to MPEG video clips.

After the user completes a search query, the query may be sent to the broker which functions as described above in order to find matching files on the network. The broker may locate every content tracker available on the system, and sort them in accordance with a predetermined criteria, such as by the price each asks to perform a lookup operation and secondarily by reputation. Then, the broker pays one or more content trackers to search their respective databases for the user's search string. If the content tracker can match a filename or description to that string, the tracker returns information about that file to the user, including the dinode. The user can then attempt to retrieve the file.

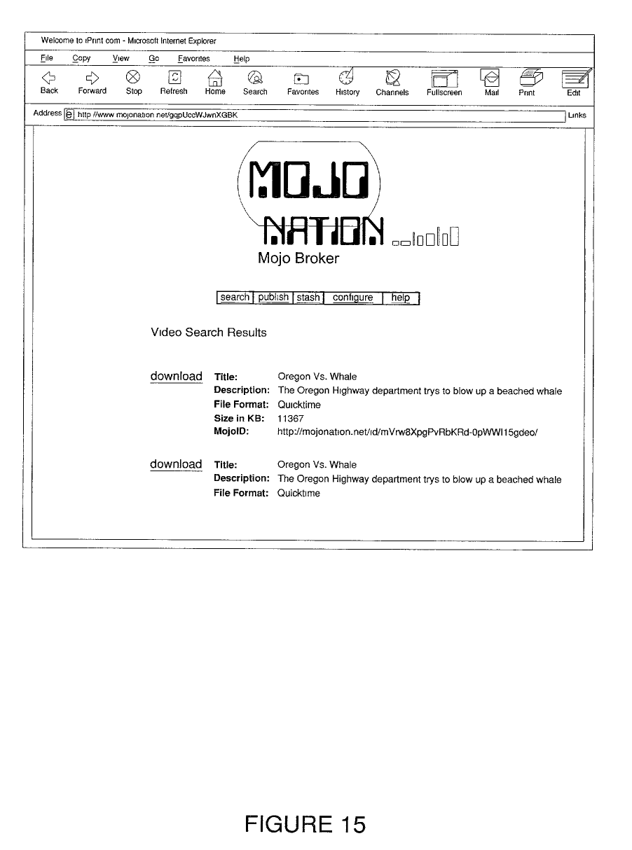

When the search is complete, the broker causes the client to display the search results to the user via the web browser. FIG. 15 is an exemplary screenshot showing the results of a search for video clips. The search results contain a list of all documents found that match the requested search criteria. However, since subscribers who contribute resources to the network do not always maintain active connections to the network, the results of the search may vary depending on the number of users on the system who may be contributing particular resources, such as storage space. A user may elect to download a resulting file, for example by selecting the “download” hyperlink 180 or other equivalent selecting means on the search results webpage. If the file can be displayed in the user's browser, it may be so displayed. Alternatively, the file may be saved to the user's local disk drive, or on other storage media.

When a user attempts to retrieve a file from the network, the broker first examines the list of the block servers from which the user has purchased blocks before and tries to use those block servers. Otherwise, the broker asks the metatracker to find block servers whose range of carried block IDs includes those which make up chunks of the requested file (as the amount of data in the system grows, a block server will narrow the range of blocks it carries, depending on the local disk space). If every chunk of the file, any four of the eight blocks into which a chunk is broken are used for rebuilding the chunk, can be reassembled, the file can be rebuilt along with the sharemap and passed to the user. [Note to Jim: Please provide a detailed explanation of how files are reassembled, i.e., an example.]

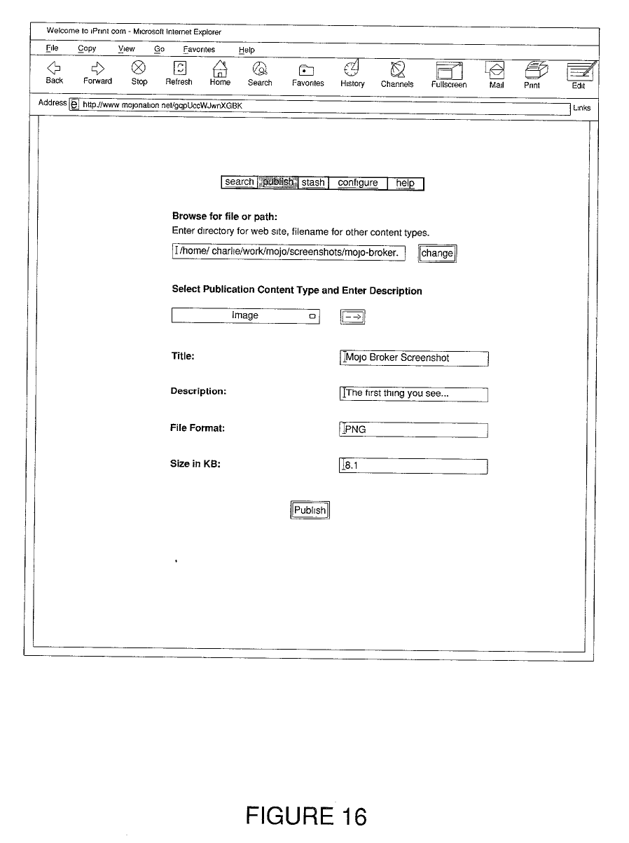

Upon selecting the “publish” hyperlink 162, a user may publish digital content to the network, such as music files, video images, software, documents, and other types of files. The user may be presented with a publish menu 190, an exemplary screenshot of which is shown in FIG. 16, and can interact with the menu 190 to select a particular file to publish to the network, by entering the name of the file (and its location) in a data field 192. Depending on the type of content the user is uploading to the network, the browser may display a series of data fields 194 relating to the content type for characterizing the content type, such as title, description, file format, file size, and other information about the file. Advantageously, there are no restrictions on the size or type of file that may be published on the network. However, the larger the file, the more digital currency will be expended in publishing it to the network, as described above.

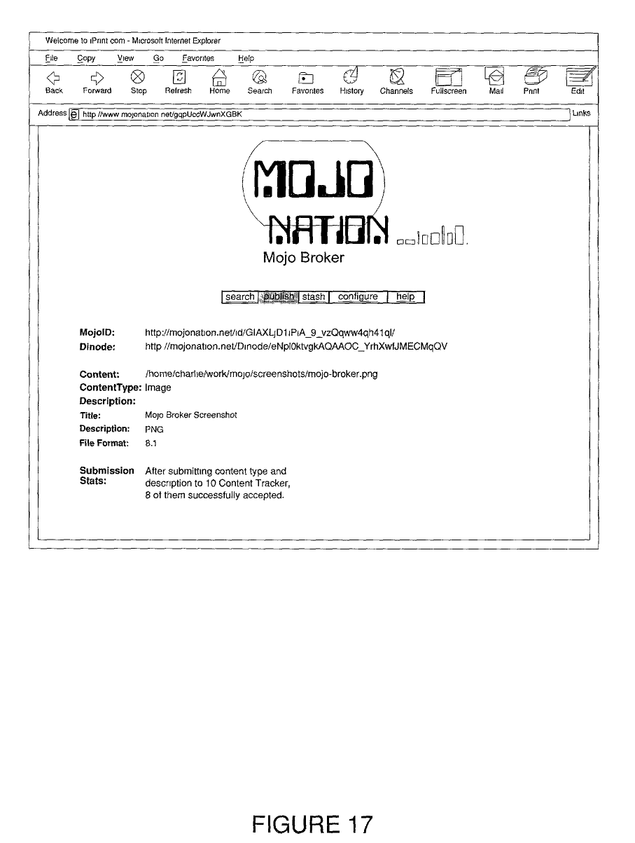

When the user is finished entering information about the file on the publish menu webpage, the user may submit the publish request, at which time the broker will attempt to upload the file to the network, as described above. The file may be encrypted, broken into pieces, and stored in various locations around the network. After the upload is complete, the broker may cause the client to display a confirmation webpage to the user via the web browser which may include the files network identifier (a unique specially formatted URL that the broker can use to locate the file on the network). FIG. 17 is an exemplary screenshot of a confirmation page that may be displayed to a user upon successfully uploading a file to the network.

The present invention enables users located behind firewalls, or otherwise connecting to the Internet through a service that does not accept random incoming connections, to access the network using a relay server. The relay server holds the user's system messages outside the firewall, or its equivalent, until the user's broker exits the firewall to retrieve the messages. A broker that desires to use a relay service first asks a metatracker for the other brokers online that are providing relay service. After the broker shops for the least-expensive relay service and makes a connection with that server, messages sent to that relay server on the broker's behalf are held there until the broker picks up the messages. The relay server acts as an answering service, collecting messages for brokers that are registered there, and then delivering them as requested.

Accordingly, the invention provides an infrastructure of a distributed society of independent agents, that maintains a higher degree of reliability and fault tolerance than a centralized system because users can look across the entire system for information and services rather than requesting them from a central server.

Resources that may be shared by users include, for example, storage space whenever that user is online, caching popular content on that user's computer, hosting a tracker service to help other users find particular content or resources, providing a relay service, so that users who work behind a firewall can access the network via that user's computer.

The system uses strong cryptography (RSA public-key encryption, DESX, SHA1) to authenticate agents and guarantee data integrity. The encryption protects communications between peers from casual observation and enhances user privacy. The data transport security protocols also prevent spoofing and most active attacks on the network.

What is claimed is:

1. A distributed system for publishing and retrieving content in a network, comprising:
a plurality of computer systems connected together in a peer-to-peer fashion;
one or more agent applications associated with the computer systems for allowing the computer systems to publish and retrieve content from the network by initiating peer-to-peer interactions across the network involving given transaction costs.

2. The distributed system of claim 1, wherein the computer systems have characterized network resources that can be contributed to the network in return for a predetermined amount of credits that are accumulated by those computer systems contributing resources to the network such that the computer systems can exchange the credits for performing interactions across the network.

3. The distributed system of claim 2, wherein the network resources include any of disk space, bandwidth, and CPU processing cycles.

4. The distributed system of claim 2, wherein the interactions are performed by the agent applications.

5. The distributed system of claim 2, wherein credits are purchased directly without contributing resources to the network.

6. The system of claim 1, wherein each interaction across the network involves a transaction cost.

7. The system of claim 6, wherein the interactions are performed by the agent applications.

8. The distributed system of claim 1, further comprising a credit server for maintaining a database of previously used credits and for authorizing a valid credit transaction between interacting agent applications within the network.

9. The distributed system of claim 1, wherein the agent applications comprise one or more client agent applications for enabling the computing systems access and interact with the agent applications in the network, one or more broker agent applications for performing brokering transactions between the agent applications in the network, one or more tracker agent applications for providing a listing of available resources within the network, one or more reputation agent applications for tracking the reputations of the computer systems in the network, and one or more payment agent applications for validating credit transactions within the network.

10. The distributed system of claim 9, wherein the one or more broker agent applications directly provide brokered network resources to requesting computer systems within the network.

11. The distributed system of claim 9, wherein the one or more tracker agent applications include one or more metatracker agent applications for maintaining the network location of the one or more active broker agent applications and a listing of the associated resources that those active broker agent applications broker within the network, one or more content tracker agent applications for storing dinodes to locate data blocks constituting a published data file on the network, and one or more publication tracker agent applications for recording storage locations on particular computing systems where the data blocks are stored.

12. The distributed system of claim 11, wherein the tracker agent applications maintain public information relating to the various agent applications within the network.

13. The distributed system of claim 9, wherein the client, broker, tracker, reputation, and payment agent applications are integrated as a single agent application.

14. The distributed system of claim 9, wherein the peer-to-peer interactions are performed in accordance with a micropayment transaction process.

15. The distributed system of claim 14, wherein the micropayment transaction process includes causing the client agent application associated with a first computing system to offer a given amount of credits to a broker application associated with a second computing system for performing the transaction within the network, causing the broker application to loan to the client application an amount of credits equal to the offered amount of credits to enable the first and second computing systems to engage in the transaction, causing the payment agent to verify the offered credits to insure that the offered credits have not been previously spent in a prior transaction and withdraw the offered credits from future use within the network, and if verified, causing the broker application to complete the transaction and retract the loaned credits in return for new credits that are associated with the second computing system in an amount equal to the amount of offered credits.

16. The distributed system of claim 11, wherein the broker agent applications publish content to the network by receiving an original file to be published to the network, dissecting the original file into a series of pieces of the original file, further dissecting each piece of the original file into a predetermined number of file blocks, generating a respective block identification tag for each of the file blocks, and storing the file blocks on one or more storage block servers within the network.

17. The distributed system of claim 16, wherein the broker agent applications further generate a sharemap for the original file that describes how to reassemble the pieces of the original file from the file blocks and the original file from the pieces of the original file.

18. The distributed system of claim 17, wherein portions of the sharemap are stored at one or more dinodes within the network, and wherein the content tracker maintains information about the dinodes within the network so that the original file can be reassembled.

19. The distributed system of claim 16, wherein the file blocks are retrieved in parallel to reassemble the original file.

20. The method of claim 19, wherein only a portion of the file blocks are needed to reassemble the original file.

21. The distributed system of claim 1, wherein the system uses a protocol for transmitting messages between the agents, the protocol including a transport layer for moving secure data between the agents, an encryption and authentication layer for encrypting and decrypting the data, a conversation layer for associating initiating messages with their responding messages counterparts, and a transaction layer for enabling the interactions between the agents in the network.

22. A distributed system for publishing and retrieving content in a network, comprising:
a plurality of computer systems connected together in a peer-to-peer fashion and having characterized network resources that can be contributed to the network in return for a predetermined amount of credits that are accumulated by those computer systems contributing resources to the network such that the computer systems can exchange the credits for performing interactions across the network; and
one or more agent applications associated with the computer systems for allowing the computer systems to publish and retrieve content from the network by initiating the peer-to-peer interactions across the network between the agent applications.

23. The distributed network of claim 22, wherein the network resources include any of disk space, bandwidth, and CPU processing cycles.

24. The distributed network of claim 23, wherein each interaction across the network involves a transaction cost.

25. The distributed system of claim 22, further comprising a credit server for maintaining a database of previously used credits and for authorizing a valid credit transaction between interacting agent applications within the network.

26. The distributed system of claim 22, wherein the agent applications comprise one or more client agent applications for enabling the computing systems access and interact with the agent applications in the network, one or more broker agent applications for performing brokering transactions between the agent applications in the network, one or more tracker agent applications for providing a listing of available resources within the network, one or more reputation agent applications for tracking the reputations of the computer systems in the network, and one or more payment agent applications for validating credit transactions within the network.

27. The distributed system of claim 26, wherein the one or more broker agent applications directly provide brokered network resources to requesting computer systems within the network.

28. The distributed system of claim 26, wherein the one or more tracker agent applications include one or more metatracker agent applications for maintaining the network location of the one or more active broker agent applications and a listing of the associated resources that those active broker agent applications broker within the network, one or more content tracker agent applications for storing dinodes to locate data blocks constituting a published data file on the network, and one or more publication tracker agent applications for recording storage locations on particular computing systems where the data blocks are stored.

29. The distributed system of claim 28, wherein the tracker agent applications maintain public information relating to the various agent applications within the network.

30. The distributed system of claim 26, wherein the client, broker, tracker, reputation, and payment agent applications are integrated as a single agent application.

31. The distributed system of claim 26, wherein the peer-to-peer interactions are performed in accordance with a micropayment transaction process.

32. The distributed system of claim 31, wherein the micropayment transaction process includes causing the client agent application associated with a first computing system to offer a given amount of credits to a broker application associated with a second computing system for performing the transaction within the network, causing the broker application to loan to the client application an amount of credits equal to the offered amount of credits to enable the first and second computing systems to engage in the transaction, causing the payment agent to verify the offered credits to insure that the offered credits have not been previously spent in a prior transaction and withdraw the offered credits from future use within the network, and if verified, causing the broker application to complete the transaction and retract the loaned credits in return for new credits that are associated with the second computing system in an amount equal to the amount of offered credits.

33. The distributed system of claim 28, wherein the broker agent applications publish content to the network by receiving an original file to be published to the network, dissecting the original file into a series of pieces of the original file, further dissecting each piece of the original file into a predetermined number of file blocks, generating a respective block identification tag for each of the file blocks, and storing the file blocks on one or more storage block servers within the network.

34. The distributed system of claim 33, wherein the broker agent applications further generate a sharemap for the original file that describes how to reassemble the pieces of the original file from the file blocks and the original file from the pieces of the original file.

35. The distributed system of claim 34, wherein portions of the sharemap are stored at one or more dinodes within the network, and wherein the content tracker maintains information about the dinodes within the network so that the original file can be reassembled.

36. The distributed system of claim 33, wherein the file blocks are retrieved in parallel to reassemble the original file.

37. The distributed system of claim 36, wherein only a portion of the file blocks are needed to reassemble the original file.

38. The distributed system of claim 22, wherein the system uses a protocol for transmitting messages between the agents, the protocol including a transport layer for moving secure data between the agents, an encryption and authentication layer for encrypting and decrypting the data, a conversation layer for associating initiating messages with their responding messages counterparts, and a transaction layer for enabling the interactions between the agents in the network.

39. A distributed system for publishing and retrieving content in a network, comprising:
a plurality of computer systems connected together in a peer-to-peer fashion and having characterized network resources that can be contributed to the network in return for a predetermined amount of credits that are accumulated by those computer systems contributing resources to the network such that the computer systems can exchange the credits for performing interactions across the network; and
a global pool of agent applications distributed across the network for allowing the computer systems to publish and retrieve content from the network by initiating the peer-to-peer interactions across the network.

40. The distributed network of claim 39, wherein the network resources include any of disk space, bandwidth, and CPU processing cycles.

41. The distributed network of claim 39, wherein each interaction across the network involves a transaction cost.

42. The distributed system of claim 39, further comprising a credit server for maintaining a database of previously used credits and for authorizing a valid credit transaction between interacting agent applications within the network.

43. The distributed system of claim 39, wherein the global pool of agent applications comprises one or more client agent applications for enabling the computing systems access and interact with the agent applications in the network, one or more broker agent applications for performing brokering transactions between the agent applications in the network, one or more tracker agent applications for providing a listing of available resources within the network, one or more reputation agent applications for tracking the reputations of the computer systems in the network, and one or more payment agent applications for validating credit transactions within the network.

44. The distributed system of claim 40, wherein the one or more broker agent applications directly provide brokered network resources to requesting computer systems within the network.

45. The distributed system of claim 43, wherein the one or more tracker agent applications include one or more metatracker agent applications for maintaining the network location of the one or more active broker agent applications and a listing of the associated resources that those active broker agent applications broker within the network, one or more content tracker agent applications for storing dinodes to locate data blocks constituting a published data file on the network, and one or more publication tracker agent applications for recording storage locations on particular computing systems where the data blocks are stored.

46. The distributed system of claim 45, wherein the tracker agent applications maintain public information relating to the various agent applications within the network.

47. The distributed system of claim 43, wherein the client, broker, tracker, reputation, and payment agent applications are integrated as a single agent application.

48. The distributed system of claim 43, wherein the peer-to-peer interactions are performed in accordance with a micropayment transaction process.

49. The distributed system of claim 48, wherein the micropayment transaction process includes causing the client agent application associated with a first computing system to offer a given amount of credits to a broker application associated with a second computing system for performing the transaction within the network, causing the broker application to loan to the client application an amount of credits equal to the offered amount of credits to enable the first and second computing systems to engage in the transaction, causing the payment agent to verify the offered credits to insure that the offered credits have not been previously spent in a prior transaction and withdraw the offered credits from future use within the network, and if verified, causing the broker application to complete the transaction and retract the loaned credits in return for new credits that are associated with the second computing system in an amount equal to the amount of offered credits.

49. The distributed system of claim 45, wherein the broker agent applications publish content to the network by receiving an original file to be published to the network, dissecting the original file into a series of pieces of the original file, further dissecting each piece of the original file into a predetermined number of file blocks, generating a respective block identification tag for each of the file blocks, and storing the file blocks on one or more storage block servers within the network.

50. The distributed system of claim 49, wherein the broker agent applications further generate a sharemap for the original file that describes how to reassemble the pieces of the original file from the file blocks and the original file from the pieces of the original file.

51. The distributed system of claim 50, wherein portions of the sharemap are stored at one or more dinodes within the network, and wherein the content tracker maintains information about the dinodes within the network so that the original file can be reassembled.

52. The distributed system of claim 50, wherein the file blocks are retrieved in parallel to reassemble the original file.

53. The distributed system of claim 52, wherein only a portion of the file blocks are needed to reassemble the original file.

54. The distributed system of claim 39, wherein the system uses a protocol for transmitting messages between the agents, the protocol including a transport layer for moving secure data between the agents, an encryption and authentication layer for encrypting and decrypting the data, a conversation layer for associating initiating messages with their responding messages counterparts, and a transaction layer for enabling the interactions between the agents in the network.

55. A method for performing micropayment transactions in a distributed network, comprising the steps of:
offering a given amount of credits to a first party for performing a transaction within the network;
loaning to a second party an amount of credits equal to the offered amount of credits to enable the first and second parties to engage in the transaction;
verifying the offered credits to insure that the offered credits have not been previously spent in a prior transaction and withdrawing the offered credits from future use; and
if verified, completing the transaction and retracting the loaned credits to the second party in return for new credits that are associated with the first party in an amount equal to the amount of offered credits.

56. The method of claim 55, wherein the transaction is a direct transaction.

57. The method of claim 56, wherein during the direct transaction a request for network resources is transmitted directly to a broker agent that can fulfill the request by brokering the requested network resources.

58. The method of claim 55, wherein the transaction is an indirect, transparent transaction.

59. The method of claim 58, wherein during the indirect, transparent transaction a request for network resources is transmitted directly to one or more intermediate broker agents and wherein those intermediate broker agents locate a particular provisioning broker agent that can fulfill the request for the least cost and transmit the request to that provisioning broker agent to fulfill the request by brokering the requested network resources.

60. A method for performing a microaccount transaction in a distributed network, comprising the steps of:
initiating a transaction session between a requesting party and a fulfilling party within the network where the parties determine a financial relationship between them for guiding the transaction;
creating a token for use in a transaction between the parties, the transaction having a given cost, and associating a digital signature with the token;
verifying the authenticity of the token and associating an appropriate denomination with the token equal to the given cost for fulfilling the transaction;
fulfilling the transaction in exchange for the token; and
withdrawing the token from future use and associating a new token in an amount equal to the given cost with the fulfilling party.

61. The method of claim 60, wherein the initiating step includes exchanging a shared secret encryption key between the parties.

62. The method of claim 60, wherein the transaction is a direct transaction.

63. The method of claim 62, wherein during the direct transaction a request for network resources is transmitted directly to a broker agent that can fulfill the request by brokering the requested network resources.

64. The method of claim 60, wherein the transaction is an indirect, transparent transaction.

65. The method of claim 64, wherein during the indirect, transparent transaction a request for network resources is transmitted directly to one or more intermediate broker agents and wherein those intermediate broker agents locate a particular provisioning broker agent that can fulfill the request for the least cost and transmit the request to that provisioning broker agent to fulfill the request by brokering the requested network resources.

66. A method for publishing content to a distributed network, comprising the steps of:
receiving an original file to be published to the network;
dissecting the original file into a series of pieces of the original file;
further dissecting each piece of the original file into a predetermined number of file blocks;
generating a respective block identification tag for each of the file blocks; and
storing the file blocks on one or more storage block servers within the network.

67. The method of claim 66, further comprising the steps of generating a sharemap for the original file that describes how to reassemble the pieces of the original file from the file blocks and the original file from the pieces of the original file.

68. The method of claim 67, wherein portions of the sharemap are stored at one or more dinodes within the network.

69. The method of claim 66, wherein the block identification tag is generated by processing each file block with a cryptographic hash algorithm.

70. The method of claim 66, wherein the block servers comprise available storage space on one or more allocated disk drives on one or more computer systems associated with the network.

71. The method of claim 66, wherein the file blocks are retrieved in parallel to reassemble the original file.

72. The method of claim 71, wherein only a portion of the file blocks are needed to reassemble the original file.

73. A protocol for transmitting messages between agents in a distributed network, comprising:
a transport layer for moving secure data between the agents;
an encryption and authentication layer for encrypting and decrypting the data;
a conversation layer for associating initiating messages with their responding messages counterparts; and
a transaction layer for enabling interactions between the agents in the network.

74. The protocol of claim 73, wherein the transport layer utilizes TCP/IP to move secure data between the agents.

75. The protocol of claim 73, wherein the conversation layer assigns a nonce to an initiating message and monitors responding messages for the occurrence of the nonce and associating the messages whose nonces match.

76. The protocol of claim 75, wherein the occurrence of the nonce in a responding message is in a hashed format.
